(19) United States
(12) Patent Application Publication
(10) Pub. No.: US 2002/0002522 A1
(43) Pub. Date: Jan. 3, 2002

(54) System and method for improving productivity of individual persons

(76) Inventor: John Lawrence Clift, Queensland (AU)

Correspondence Address: BAKER & MCKENZIE, 805 THIRD AVENUE, NEW YORK, NY, 10022, US

(21) Appl. No.: 09/829,072

(22) Filed: Apr. 9, 2001

(30) Foreign Application Priority Data
Apr. 7, 2000 (AU) PQ6774

(51) Int. Cl. G06F 17/60

(52) U.S. Cl. 705/36

(57) ABSTRACT

The present invention considers each person or worker in an economic entity as an individual business unit (“IBU”) with its own allocated revenue, cost and profit which can be controlled by the IBU. The profit allocated to the IBU belongs to the IBU itself. In effect, each IBU is valued as a business within the larger economic entity in which the IBU works. A profit potential of an IBU is determined by calculating the revenue and cost which are attributable to the IBU. The determined profit potential as capitalized over a predetermined time period becomes a tradable commodity for sale.

Each IBU's effort is now linked to its own profit potential. If the IBU decreases its allocated cost or increases its allocated revenue, its allocated profit increases in proportion. The increased profit in turn increases the IBU's capitalized value. As a result, each IBU has a substantial incentive to increase its productivity in an attempt to increase its capitalized value.

### CROSS REFERENCE TO RELATED APPLICATIONS

This application claims the benefit of Australian Provisional Application No. PQ6774 filed Apr. 7, 2000.

1. Technical Field

The present invention relates to productivity enhancement methods and, in particular, methods to increase productivity of individual persons.

2. Background of the Invention

In a business organization, each employee often works for a salary and the business organization keeps all profit generated by the employees. In a conventional medical practice, for example, one or more doctors are employed under contract to the owner of the practice. The doctors provide a gross revenue that is equivalent to the sum of each doctor's gross billings. Out of these gross billings, the practice pays each doctor a salary and pays any other costs or expenses associated with the running of the practice. Any remaining amount is retained by the owner of the practice as profit.

One disadvantage with a conventional way of running a business such as a medical practice is that it does not provide the contracted doctors with any great incentive to improve their productivity by either increasing their gross billings or reducing the costs associated with the practice. In the past, various profit sharing plans have been developed in an attempt to provide an incentive to the employees to increase their productivity. These plans, however, are not very effective because there is no direct relationship between profit and individual employee's effort. Each employee feels that no matter how hard he or she tries, the business profit depends on many factor that are beyond the control of any one employee. In the case of a medical practice, although the doctors employed by the practice are essentially guaranteed an income, they do not feel motivated to increase the profit of the practice because the practice owner keeps all of the generated profit.

Therefore, it is apparent that there is a need for a system and method that addresses the problems associated with the aforementioned conventional business practices.

### SUMMARY OF THE INVENTION

Unlike a conventional business where individual workers work for predetermined salary and profits generated by the workers are retained by the business, the present invention considers one or more persons or workers in an economic entity as individual business units (“IBU”) each with its own allocated revenue, cost and profit which can be controlled by the IBU. Unlike the conventional business, the profit allocated to the IBU belongs to the IBU itself. In effect, each IBU is valued as a business within the larger economic entity in which the IBU works.

According to the principles of the present invention, a profit potential of an IBU representing a natural person in a business entity is determined by calculating the revenue and cost which are attributable to the IBU. The determined profit potential is then capitalized. The capitalized value is a tradable commodity that can be sold to a third party for a loan and is paid back to the third party from the future profit of the IBU. One method of capitalization is to add all the future profit streams over a predetermined time period. Another capitalization method is to use a discount factor to calculate a present value of the profit stream. Yet another capitalization method is to use an earnings multiple.

As can be appreciated, each IBU's effort is now linked to its own profit potential. If the IBU decreases its allocated cost or increases its allocated revenue, the profit attributable to it increases in proportion. The increased profit in turn increases the IBU's capitalized value. As a result, each IBU has a substantial incentive to lower the cost or increase the revenue in an attempt to increase its capitalized value.

From the viewpoint of a buyer of capitalized values, the buyer makes money from the interest on the loan. If the buyer is a professional management company having a large number of business entities under management, for example a medical practice management company, it has other sources of income from the arrangement. In return for buying the capitalized values from the IBUs', the management company can contract with various IBUs' to allow it to collect at least a portion of referral fees from various entities such as specialists and hospital support entities. Often, the income generated from these collateral sources for the management company can be substantially greater than the income it makes from the loans on the IBUs' capitalized profits.

### BRIEF DESCRIPTION OF THE DRAWINGS

FIG. 1A is a diagram illustrating the profit potential of doctors as IBUs' which are bought by their practice owner.

FIG. 1B is a diagram illustrating the profit potential of doctors as IBU's which are bought by a third party business entity.

FIG. 1C is a diagram illustrating a third party business entity's purchase of both the future profit potential of doctors as IBU's and the future profit potential of the practice owner as another IBU.

FIG. 2 is a flow diagram illustrating a method of determining IBU profits for sale.

FIG. 3 is a diagram illustrating the profit potential of various IBUs' using allocation factors.

FIG. 4 is a diagram illustrating the profit potential of various IBUs' and indirect IBUs' using allocation factors.

### DETAILED DESCRIPTION OF THE INVENTION

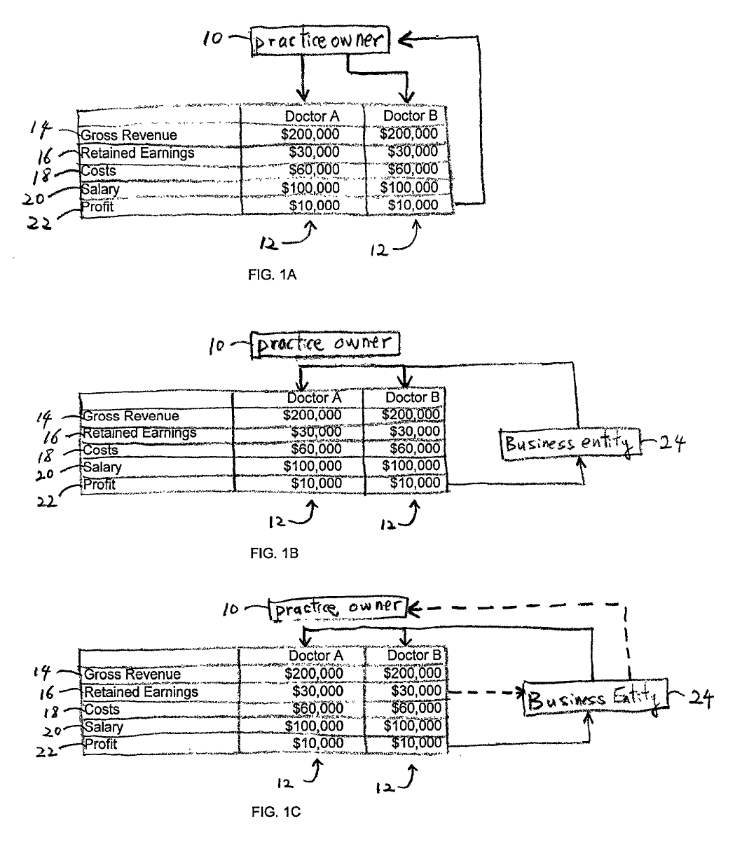

Although the present system can be implemented in any economic entity, it will be described in the context of a medical practice. A medical practice in FIG. 1A comprises a practice owner 10 that owns the practice and employees employed by the practice owner. The practice owner 10 can be a natural person or legal entity. The employees illustrated in FIG. 1A are two doctors A and B.

The practice owner 10 has responsibilities that include, but are not limited to providing the doctors with a work environment and managing the practice. The work environment may include a building equipped with all of the necessary equipment that a medical practice requires (e.g., a consulting room, medical equipment, telephones and computers).

According to the invention, each doctor is viewed as an IBU (individual business unit) 12. As an IBU 12, each doctor has a gross revenue 14 allocated to it. Generally, the gross revenue of a doctor is substantially equal to the service fees or gross billings collected from the patients or their insurance companies. Each IBU 12 pays retained earnings 16 to the practice owner 10. The retained earnings item 16 is equivalent to the amount of money guaranteed to be paid by the doctor to the practice owner 10 for the privilege of practicing medicine in the work environment provided by the practice owner 10. The retained earnings 16 to be paid to the owner 10 is often a percentage of the revenue of the doctors.

The total cost 18 incurred by the IBU 12 is deducted from the gross revenue 14 of the respective unit. In other words, it is the individual business unit 12 who is responsible for covering any costs 18 that it incurs and not the practice owner 10. The costs 18 can include fixed costs and variable costs. The fixed costs can include for example such items as insurance, rent, lease payments, or the like while variable costs can include for example the cost of syringes, surgical gloves, pencils or the like.

After deducting retained earnings 16 and costs 18 from its gross revenue 14, the IBU 12 is left with a salary item 20 and a profit item 22. Generally, the salary item 20 is a salary that the IBU 12 negotiates at the outset of its contract with the practice owner 10. The profit item 22 is any remaining percentage of the IBU's gross revenue that is outside of any other items.

Unlike a conventional business model, the profit item 22 according to the present invention belongs to the individual business unit 12 that earned it. The expected future profit 22 over a predetermined time period is capitalized which can then be sold as a tradable commodity. The profit stream can be handled in many different ways. In order to acquire the services of the IBUs', their capitalized profit streams are bought. In FIG. 1A, the profit stream can be is sold to the practice owner 10 for a cash value. Alternatively it can be exchanged for an equity stake in the medical practice business of the owner 10. Still in another alternative, the IBU's profit stream can be partially sold for cash and partially exchanged for the equity stake depending on the risk tolerance of the IBU 12.

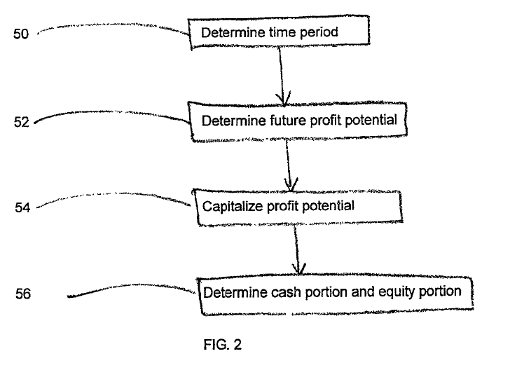

FIG. 2 illustrates one method of determining the value of an individual business unit. In step 50, an appropriate time period is determined during which the profit potential of the IBU 12 is to be capitalized. In step 52, the profit potential during the time period is calculated. Referring to FIG. 1A, each of Doctor A and B as an IBU 12 has a gross revenue per year 14 of $200,000. Each IBU 12 has contracted to provide the practice owner 10 with a retained earnings 16 of 15% of revenue 14. Since the revenue per each doctor is $200,000, each IBU pays $30,000 per year of retained earnings 16 to the owner 10. The IBU 12 elects a salary 20 of $100,000 per year. The total costs 18 incurred by each IBU 12 in one year is $60,000. Subtracting the retained earnings 16, cost 18 and salary 20 from the gross revenue 14 leaves $10,000 as the profit potential 22 of the individual business unit 12 per year which is assumed to be earned at the end of the year.

Further assume that every line item in the table of FIG. 1A stays the same the following year for the purpose of determining a future profit stream. Thus, the profit potential 22 for the following year is also $10,000. If the time period determined in step 50 is assumed to be two years and the contract between the practice owner 10 and the IBU 12 runs for two years, then the future profit stream includes $10,000 for the first year and $10,000 for the second year for each IBU.

Referring back to FIG. 2, the future profit stream is capitalized in step 54, meaning that the periodic profit stream is converted into an equivalent capital sum. Capitalizing the profit stream may involve simply adding the yearly profit numbers together. In that case, the capitalized profit potential for the two year period for each IBU 12 is $20,000. According to the present invention, this capitalized profit potential becomes the tradable commodity.

Alternatively, capitalizing can involve a discount factor to discount the future profit stream to the present value. For example, if the discount rate is 10%, then the capitalized profit potential would be ($10,000/1.1)+($10,000/1.1ˆ 2) which yield $17,355 as the capitalized value for sale.

In step 56, each IBU 12 and a potential buyer of the capitalized profit stream allocate how much of the capitalized profit is to be sold for cash and how much is to be exchanged for equity in the buyer. For example, the IBU 12 and the buyer can agree to apportion 40% to cash and 60% to equity. The buyer of the capitalized value can be any entity. In FIG. 1A, the practice owner 10 itself is the buyer. Assuming for simplicity that the capitalized value determined in step 54 is $100,000, the owner in this example immediately pays $40,000 to the IBU 12 as a loan to be paid back by the future profit stream of the IBU 12. Further, the owner 10 gives an equity stake in its medical practice business worth $60,000. The cost of the equity stake is also paid back to the owner from the future profit stream of the IBU.

As shown in FIG. 1B, the IBU 12 can contract with a third party business entity 24 to sell the capitalized value for a predetermined time period for cash and/or equity stake in the form of stocks or stock options, warrants or the like. The entity 24 is generally a professional management company that manages a group of similar businesses. In this embodiment, the equity portion can be very attractive because the business entity 24 has the potential to grow and eventually go public to become a publicly traded listed company. When the entity 24 goes public, the equity stake held by the IBU 12 can be worth many times the value of its original investment. The shares become also publicly tradable allowing the IBU 12 to cash out its equity stake very easily. The cost of cash (loan) and the equity stake taken by the IBU 12 are paid back to the entity 24 by the future profit stream of the IBU 12 during the contract period.

If the entity 24 does not wish to tie up its capital with the IBUs', it can arrange to have a financial institution (not shown) provide the loans instead to the IBUs'. The loans can be guaranteed by the future profit stream of the IBUs' or by the entity 24 itself.

In conventional medical practice or any other business, the business entity keeps the profit generated by each employee. No matter how hard the employee works, compensation is limited to the salary and possibly some form of indirect profit sharing plan. However, this does not provide sufficient incentive for any employee to increase his productivity because there is no direct link between the employee's effort and profit.

According to the present invention, however, there is a direct relationship between IBU's efforts and the increase in capitalized value because each IBU 12 has control over at least some elements of its own allocated revenue and costs. By maximizing its allocated revenue, by for example seeing more patients, and minimizing its allocated costs, by for example sterilizing syringes rather than throwing them away after each use, the IBU 12 can directly increase its capitalized value.

When the current contract with the business entity 24 ends, the IBU 12 can negotiate a better contract with more cash and equity due to its higher capitalized value. Moreover, each IBU 12 now has an incentive to work together with other IBUs' to reduce costs that can be more easily controlled by all IBUs' such as reducing the temperature of the work place by one degree to reduce heating costs. The cost saved by such effort will be passed on to all IBUs' which increases every IBU's capitalized value. As can be appreciated, the present system provides the IBUs' with a powerful incentive to work harder, look for ways to reduce cost and thereby increase their productivity.

The buyer of capitalized values from IBUs' also benefits from the arrangement. If a discount factor was used to calculate the capitalized value, the buyer earns an interest on the loan to the IBUs. Also, during the contract period, the buyer participates in increased productivity of the IBUs'. If the buyer is the practice owner 10, then retained earnings 16 increases during the contract period as the IBUs' work harder to increase their capitalized values. For example, assume that the IBU 12 increases its revenue 14 by an additional $10,000 without any increase in cost 18, thereby generating an additional $10,000 in cash. During the contract period, the extra $10,000 is equally divided between the IBU 12 and the practice owner 10. This is considered fair since the practice owner 10 is considered to be at least partially responsible for providing the incentive for the IBU 12 to work harder by capitalizing the IBU's profits.

If the buyer is the business entity 24, then the $10,000 in extra earnings can be divided among the owner 10, IBU 12 and the entity 24 in any manner as agreed upon among the parties involved. For example, the owner can receive $1,500 as extra retained income 16, and the remaining $8,500 can be divided equally between the IBU 12 and the entity 24. Again, this is considered fair since the entity 24 provided the incentive for the IBU 12.

If the buyer is a professional management company 24 having a large number of medical offices under management, it has another source of income from the arrangement. In return for buying the capitalized values from the IBUs', the management company 24 can contract with various IBUs', and if necessary with their practice owners 10, to allow it to collect referral fees from various entities such as specialists and hospital support entities. The support entities can be for example X-ray companies, testing laboratories or the like. The entities enter into contracts with the management company to pay referral fees for all patients referred to by the IBUs'.

Indeed, the income generated from these collateral sources for the management company 24 can dwarf the income from the loans on the IBUs' capitalized profits. For example, the yearly referral fees from specialists referred to by one IBU 12 can be approximately $4000 based on a conservative assumption that an IBU sees an average of 8000 patients per year, about 10% of the patients are referred to specialists, and each referral fee is $5.

The principles of the present invention can be applied to any currency including popularity ratings, good deeds, moral values, leadership qualities or any other “currency” that any organization values. Further, the present system is international and convertible. It will apply to religious status, promotions, politicians and the like. In the case of religion, a cardinal and priests can be viewed as IBUs' whose “profit” stream can be capitalized. The “profit” of each IBU is revenue (offerings) allocated to the IBU from church members minus the costs allocated to the IBU.

Referring now to FIG. 1C, the practice owner 10 can also be considered an IBU with each doctor being IBUs 12 within a larger IBU 10. Consequently, the capitalized value of the practice owner 10 can also be sold or traded to the entity 24 as well as those of the IBUs'. For the IBU 12, the future potential of the retained earnings 16 is capitalized. Another aspect of this embodiment is that a company can be considered an IBU, a division of the company as an IBU within the company IBU, a subset of a division as a smaller IBU within the division IBU, and then further down the chain to individuals as the final units of IBU. Thus, the entity 24 can not only buy capitalized values of the IBUs' 12, but also the capitalized values of the larger IBUs'.

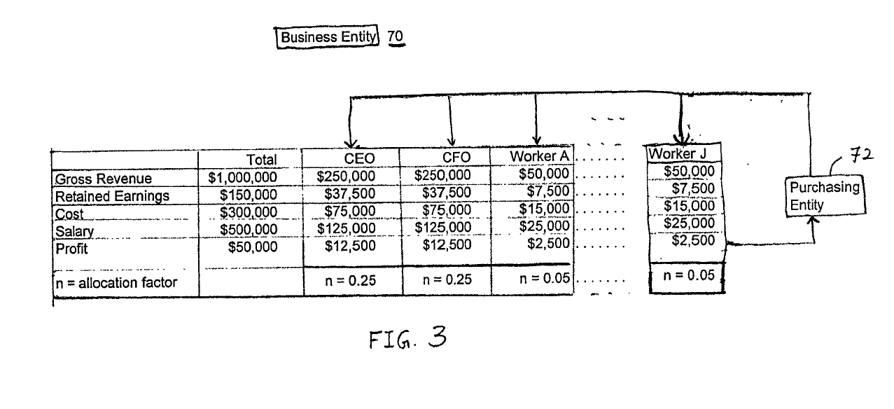

FIG. 3 further illustrates a method for determining the capitalized value of an IBU. A business entity 70 employees one chief executive officer (“CEO”), one chief financial officer (“CFO”) and 10 workers A through J. The entire business entity 70 can be considered a large IBU containing 12 IBUs' therein although in the embodiment shown the profit stream of the entity is not capitalized. The 12 IBUs' include the CEO, CFO and 10 workers A-J. The entity 70 as a whole has a gross revenue of $1,000,000, retained earnings of $150,000, costs of $300,000, salary of $500,000, and profit of $50,000 per year. Once all line items are allocated to individual employees, their profit stream over a predetermined time period is capitalized and sold to a purchasing entity 72.

The allocation of revenues, expenses and profits against IBUs', and capitalization for IBUs' can be defined using the following formulas and definitions in which upper case letters refer to the business entity 70 and lower case letters refer to IBUs within entity 70.

G=Gross revenue of an entity which may be an individual person, business, entity, a division of an entity, or even a country. G is $1,000,000 in FIG. 3.

n=Allocation factor representing a portion of a line item that is attributable to an IBU.

For example, if Gn=0.25 for the CEO, the revenue attributable for the CEO is $250,000. If the entity 70 is considered to be a country, GNP of the country is G, and G represents the right of all citizens equally, then the GNP/population would be the factor n for each citizen. The n factor can be different for each IBU for each line item. For example, Gn for Worker A can be 0.05 while Gn for Worker B can be 0.1 if Worker B is projected to contribute twice as much revenue as Worker A. Current financial analysis tools for valuing assets, costs and liabilities such as are applied by companies to current work force divisions or product runs can be used to derive the allocation factors for each IBU. Also, it is possible for an IBU to hold different n values in different levels of the economy. For example, the IBU can be in a country contributing to national GNP, in a corporation contributing to the corporation's revenue, and in a private consulting business contributing to its own revenue.

R=Retained earnings of the entity before or after tax, but preferably before interest and depreciation and whatever other variables may be considered manageable or controllable. R is $150,000 in FIG. 3.

C=Total costs including variable and fixed costs for the entity. C is $300,000 in FIG. 3.

S=Gross salaries of the IBUs' and non-IBU participants in the entity. Thus, Sn is the portion of the salary attributable to the respective IBU. S is $500,000 in FIG. 3.

P=Total Profit attributable to all IBUs'. P is $150,000 in FIG. 3. In a one person business, P and R are combined into one.

V=Variance in any factor controllable by the IBU.

Salary may vary so that an elected salary sacrifice would be seen as Sn minus Sv and would therefore contribute to profit Pn whereas a cost saving achieved is Cn minus Cv which also contributes to the profit Pn.

T=The number of periods over which the profit is to be capitalized.

For example, if 5 years is the total period and each period is one year, then T is 5. However, if the profit is averaged over the 5 year period, then T is 1.

T for the entity and t of the IBU do not have to coincide and an IBU may have several task positions (IBU sub businesses) that have different t for the same IBU. For example, an IBU may have a special project to achieve within a particular time frame, each with therefore, a separate n factor, and even a separate y factor if desired, thereby producing an extraordinary participation motivation for that IBU.

W=Capitalized value of the entity.

Again, w represents a capitalized value for the IBUs'. As can be appreciated, the advantage of the present system is that the employees as IBUs contribute to profit and management. Allowing the IBUs' to trade their capitalized value w provides substantial incentives for the IBU's to increase their productivity.

Y=Profit multiple that may be applied to earnings for the entity.

It may or may not be used as an alternative valuation technique. If not used, Y will be 1. If Y is used, then T will likely be 1. Y may also have a negative value.

R=G−(C+S+P) (1)

In equation (1), the retained earnings R which is the profit for the entity 70 is equal to the gross revenue minus (the cost plus salary plus profit for IBUs'). In FIG. 3, the retained earnings of $150,000 is derived by subtracting the cost of $300,000, salary of $500,000, and IBU profits of $50,000 from the gross revenue of $1,000,000.

W=R×T×Y (2)

In equation (2), the capitalized value W of the entity 70 is equal to the retained earnings times the number of periods times the profit multiple. In FIG. 3, assuming that Y of 5 is used, and T equals 1, the capitalized value W for the entity 70 is $750,000.

w=[Gn−(Rn+Cn+Sn)−sv−cv/4]×t×y (3)

Equation (3) is one formula for capitalizing the future profit stream of an IBU. The sv represents an elected salary sacrifice by the IBU and cv represents a cost saving to be achieved by the IBU during a contract period. Both sv and cv contribute to the profit allocated to the IBU. A sacrifice of $10,000 from the salary equates to an “sv” of −$10,000, and a cost saving of $500 equates to a “cv” of −$500. In equation (3), the cost savings cv is divided by a division factor of 4, meaning that only 25% of the cost savings is being passed to the IBU. The remaining 75% of the cost savings is divided between the business entity 70 and the purchasing entity 72 that bought the capitalized value of the IBU achieving the cost savings. For example, 25% might go to the business entity 70 through an increase in the retained earnings and 50% might go to the purchasing entity 72. This is considered fair since the purchasing entity 72 is considered to be responsible for providing the incentive for the IBU 12 to increase its productivity. On the other hand, the salary sacrifice sv is due entirely to the IBU's own choice. Thus, there is no division factor for sv.

For the next contract period where the capitalized value is renegotiated, there is no division factor for cv and the full cost savings from the previous capitalization contract is passed to the IBU, thereby lowering the cost basis Cn by the full amount cv.

w=(Pn−sv−cv/4)×t×y (4)

Equation (4) is a simpler way of defining equation (3) since Pn equals Gn−(Rn+Cn+Sn).

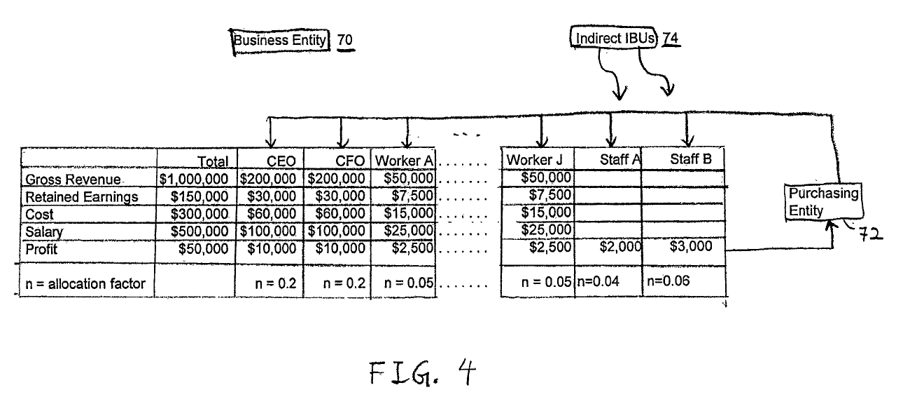

While many workers can be characterized as IBUs' to which revenues and costs can be attributed, there are some workers (indirect IBUs') where the allocation becomes difficult. In FIG. 4, staff A and staff B are such employees where there are no allocated revenue or cost. Nevertheless, to allow the indirect IBUs' to participate in the capitalization process, the present method determines an appropriate allocation factor in order to calculate the profit allocated.

In FIG. 4, staff A's n factor is 0.04 and staff B's factor is 0.06. Thus, the allocated profit to staff A or Pn equals $2,000 while Pn for staff B equals $3,000. It is important note that in calculating the profit potential of IBUs' and indirect IBUs' that the net profit P equals the sum of Pn for all IBUs' plus the sum of Pn for all indirect IBU's.

From the foregoing, it will be appreciated that, although specific embodiments of the invention have been described herein for purposes of illustration, various modifications may be made without deviating from the spirit and scope of the invention. For example, in FIG. 3 the same allocation factor of 0.25 was used for all line items for the CEO IBU. However, persons of ordinary skill in the art will appreciate that different factors for different line items for the same IBU can be used such as 0.2 for revenue and 0.3 cost. Accordingly, the present invention is not limited except as by the appended claims.

What is claimed is:

1. A method of capitalizing a person comprising:
determining a portion of a future revenue of an economic entity which is attributable to an individual business unit (IBU), the IBU representing a person in the economic entity;
determining a portion of a future cost of the economic entity which is attributable to the IBU;
determining a future profit of the economic entity which is attributable to the IBU; and
capitalizing the determined profit of the IBU.

2. The method according to claim 1 wherein the step of capitalizing includes multiplying the determined profit by a number of periods over which the IBU is to be valued.

3. The method according to claim 1 wherein the step of capitalizing includes discounting the determined profit to a present value.

4. The method according to claim 1 wherein the capitalized profit is a tradable commodity that can be sold by the IBU, further comprising determining from the capitalized profit a cash portion and an equity portion for sale to a purchasing entity, the equity portion representing an equity stake in the purchasing entity buying the capitalized value of the IBU.

5. The method according to claim 4, further comprising repaying the capitalized value from a further profit attributed to the IBU.

6. The method according to claim 1 wherein the determined profit is capitalized over a predetermined time period and is a tradable commodity that can be sold by the IBU, further comprising:
buying by a purchasing entity the capitalized profit; and
sharing between the purchasing entity and the IBU any additional profit that is generated during the predetermined period through a reduced cost attributable to the IBU or an increased revenue attributable to the IBU.

7. The method according to claim 6 wherein the capitalized profit is determined using the following formula:
w=(Pn−sv−cv/a)×t
wherein w is the capitalized profit, Pn is the determined profit attributable to the IBU, sv is a salary sacrifice by the IBU, cv is a cost saving attributable to the IBU, a is a division factor for apportioning the cost saving between the purchasing entity and the IBU, and t is a number of time periods over which the determined profit is capitalized.

8. The method according to claim 7 wherein Pn is determined by multiplying the future revenue of the economic entity by an allocation factor for the IBU.

9. The method according to claim 1, further comprising:
buying by a purchasing entity the capitalized profit; and
contracting with the IBU to permit the purchasing entity to collect at least a portion of referral fees from third party entities that are referred to by the IBU.

10. The method according to claim 1, further comprising determining an allocation factor for each IBU in the economic entity, and the profit attributable to each IBU is determined according to the allocation factor for the each IBU.

11. The method according to claim 1, further comprising:
determining an allocation factor for the IBU in the economic entity, and
wherein the revenue, cost and profit attributable to the IBU are determined according to the same allocation factor for the IBU.

12. The method according to claim 1, further comprising:
determining a profit allocation factor for a portion of the future profit of the economic entity which is associated with an indirect IBU, the indirect IBU representing a person in the economic entity and having no attributable revenue; and
determining the associated profit according to the determined profit allocation factor.

13. A method of calculating an economic worth of a person comprising:
determining a portion of a future profit of an economic entity which is attributable to an individual business unit (IBU), the IBU representing one person among a plurality of persons in the economic entity and the determined profit being owned by the IBU; and
capitalizing the determined profit of the IBU, the capitalized profit being a tradable commodity that can be sold by the IBU.

14. The method according to claim 13, further comprising determining from the capitalized profit a cash portion and an equity portion for sale to a purchasing entity, the equity portion representing an equity stake in the purchasing entity buying the capitalized value of the IBU.

15. The method according to claim 13, further comprising:
buying by a purchasing entity the capitalized profit; and
sharing between the purchasing entity and the IBU any additional profit that is generated through a reduced cost attributable to the IBU or an increased revenue attributable to the IBU.

16. The method according to claim 13 wherein the capitalized profit is determined using the following formula:
w=(Pn−sv−cv/a)×t
wherein w is the capitalized profit, Pn is the determined profit attributable to the IBU, sv is a salary sacrifice by the IBU, cv is a cost saving attributable to the IBU, a is a division factor for apportioning the cost saving between the purchasing entity and the IBU, and t is a number of time periods over which the determined profit is capitalized.

17. The method according to claim 13, further comprising:
buying by a purchasing entity the capitalized profit; and
contracting with the IBU to permit the purchasing entity to collect at least a portion of referral fees from third party entities that are referred to by the IBU.

18. A method of capitalizing a person comprising:
determining a portion of a future revenue of an economic entity which is attributable to an individual business unit (IBU), the IBU representing one worker among a plurality of workers in the economic entity and the determined profit being owned by the IBU;
determining a portion of a future cost of the economic entity which is attributable to the IBU;
determining a future profit of the economic entity which is attributable to the IBU, the determined profit being owned by the IBU;
capitalizing the determined profit of the IBU; and
selling the capitalized profit to a purchasing entity.

19. The method according to claim 18 wherein the capitalized profit is determined using the following formula:
w=(Pn−sv−cv/a)×t
wherein w is the capitalized profit, Pn is the determined profit attributable to the IBU, sv is a salary sacrifice by the IBU, cv is a cost saving attributable to the IBU, a is a division factor for apportioning the cost saving between the purchasing entity and the IBU, and t is a number of time periods over which the determined profit is capitalized.

20. The method according to claim 18 wherein Pn is determined by multiplying the future revenue of the economic entity by an allocation factor for the IBU.

21. The method according to claim 18, further comprising contracting with the IBU to permit the purchasing entity to collect at least a portion of referral fees from third party entities that are referred to by the IBU.
